(19) United States
(12) Patent Application Publication
(10) Pub. No.: US 2010/0158145 A1
(43) Pub. Date: Jun. 24, 2010

(54) MULTIPLE INPUT MULTIPLE OUTPUT RADIO COMMUNICATION SYSTEM WITH PRE-EQUALIZER AND COMMUNICATION METHOD THEREOF

(75) Inventors: Seong Chul CHO, Daejeon (KR); In Cheol JEONG, Seoul (KR); Dae Ho KIM, Daejeon (KR); Yeong Jin KIM, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/550,908

(22) Filed: Aug. 31, 2009

(30) Foreign Application Priority Data
Dec. 19, 2008 (KR) 10-2008-0130214

(51) Int. Cl. H04K 1/10

(52) U.S. Cl. 375/260

(57) ABSTRACT

Multiple Input Multiple Output (MIMO) radio communication system and method are provided. A transmitter of the MIMO radio communication system includes an STBC encoding unit, a pre-equalization unit, and a transmit antenna unit. The STBC encoding unit receives a transmit data and performs an STBC encoding to output a plurality of encoded signals. The pre-equalization unit performs a pre-equalization process on the plurality of encoded signals to output a plurality of transmit signals. The transmit antenna unit transmits the plurality of transmit signals at different time. Also, a receiver of the MIMO radio communication system which includes a receive antenna unit, an STBC decoding unit, and a data output unit is provided.

### CROSS-REFERENCE TO RELATED APPLICATIONS

This application claims priority under 35 U.S.C. §119 to Korean Patent Application No. 10-2008-0130214, filed on Dec. 19, 2008, in the Korean Intellectual Property Office, the disclosure of which is incorporated herein by reference in its entirety.

### TECHNICAL FIELD

The following disclosure relates to radio communication systems, and in particular, to Multiple Input Multiple Output (MIMO) radio communication system and method which require no channel estimation.

### BACKGROUND

MIMO technology is applied to the fourth generation (4G) mobile communications. MIMO technology provides reduced interference and higher data rate because a base station and a portable terminal transmit data over multiple paths through two or more antennas and a receiver detects signals received over the multiple paths. The transmission and reception of data through multiple antennas increases a data rate, minimizes interference, and increases capacity. Thus, MIMO technology is considered as core technology of next-generation mobile communications.

Space Time Block Coding (STBC) is a technique that is used in radio communication systems to transmit multiple copies of a data stream through multiple antennas and to exploit the various received versions of data to improve the reliability of data transfer. That is, data transmitted from a transmitter may experience a potentially difficult environment such as scattering, reflection, refraction and so on, and the transmitted data may also be corrupted by thermal noise. However, even in such an environment, some of the received copies of the transmitted data may be better than others. This redundancy enables the use of one or more of the received copies in order to correctly decode the received signal. Actually, STBC combines all the copies of the received signal in an optimal way to extract as much information as possible.

MIMO antenna transmission technique using STBC requires channel estimation for all paths arriving at multiple receive antennas from multiple transmit antennas, and performs an STBC decoding using the obtained channel estimation values.

FIG. 1 is an exemplary diagram for explaining a typical MIMO channel environment. A channel response in a 2×2 MIMO channel estimation is illustrated in FIG. 1.

As mentioned above, the MIMO antenna transmission technique using STBC requires channel estimation for all paths arriving at multiple receive antennas RX_ANT0 and RX_ANT1 from multiple transmit antennas TX_ANT0 and TX_ANT1, and performs an STBC decoding using the obtained channel estimation values. Therefore, the structure of a receiver becomes complicated.

For the STBC decoding, a MIMO radio communication system using STBC needs to know values of channel responses h₀, h₁, h₂ and h₃. Diversity gain is obtained from an STBC decoder that combines the channel estimation values and signal values received at two receive antennas. Consequently, the receiving performance is improved, but the structure of the receiver is complicated because the structure for obtaining the channel estimation values is complicated.

Meanwhile, pre-equalization is a technique that is applied when a base station knows a channel response. For example, pre-equalization technique is applied to systems using Time Division Duplex (TDD) having high channel correlation. A channel response received at a receive antenna of a receiver of a mobile station is estimated. Thus, by transmitting a signal multiplied by a conjugate of the channel response, the receiver requires no channel estimation.

Therefore, if the pre-equalization technique requiring no channel estimation is applied to the MIMO radio communication system using STBC, the structure of the receiver of the MIMO radio communication system will be simplified.

However, since interchannel interference exists in the MIMO channel having multiple receive antennas, signals are not completely separated from one another according to the receive antennas. For this reason, the systems using pre-equalization are configured with a Multiple Input Single Output (MISO) channel structure having a single receive antenna.

In the systems using pre-equalization, the channel estimation is performed at the transmitter and thus the channel estimation is not required at the receiver. However, the systems using pre-equalization cannot be used in MIMO systems.

### SUMMARY

In one general aspect, a transmitter of a MIMO radio communication system includes: an STBC encoding unit receiving a transmit data and performing an STBC encoding to output a plurality of encoded signals; a pre-equalization unit performing a pre-equalization process on the plurality of encoded signals, which are transmitted from the STBC encoding unit, to output a plurality of transmit signals; and a transmit antenna unit transmitting the plurality of transmit signals at different time.

In another general aspect, a receiver of an MIMO radio communication system includes: a receive antenna unit comprising two or more antennas and receiving a plurality of signals through the two or more antennas at different time; an STBC decoding unit performing an STBC decoding on the plurality of received signals to output a plurality of receive data signals; and a data output unit outputting contents of the receive data signals.

In another general aspect, a transmitting method of a MIMO radio communication system includes: generating a plurality of encoded signals with respect to a transmit data; performing a pre-equalization process on the plurality of encoded signals to output a plurality of transmit signals; and transmitting the plurality of transmit signals at different time.

In another general aspect, a receiving method of an MIMO radio communication system includes: receiving a plurality of receive signals through a plurality of antennas at different time; generating a receive data signal by performing an STBC decoding on the plurality of received signals by using an arithmetic operation; and outputting the receive data.

Other features and aspects will be apparent from the following detailed description, the drawings, and the claims.

### BRIEF DESCRIPTION OF THE DRAWINGS

FIG. 1 is an exemplary diagram for explaining a typical MIMO channel environment.

FIG. 2 is a configuration diagram of a transmitter of a MIMO radio communication system using pre-equalization according to an exemplary embodiment.

FIG. 3 is a configuration diagram illustrating a receiver of the MIMO radio communication system using pre-equalization according to an exemplary embodiment.

FIG. 4 is a schematic diagram for explaining the function of the transmitter according to the exemplary embodiment.

FIGS. 5 and 6 are exemplary diagrams for explaining a MIMO channel environment to which the MIMO radio communication system according to the exemplary embodiment is applied.

FIG. 7 is a flowchart illustrating a MIMO radio communication method using pre-equalization according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/of systems described herein will be suggested to those of ordinary skill in the art. Also, descriptions of well-known functions and constructions may be omitted for increased clarity and conciseness.

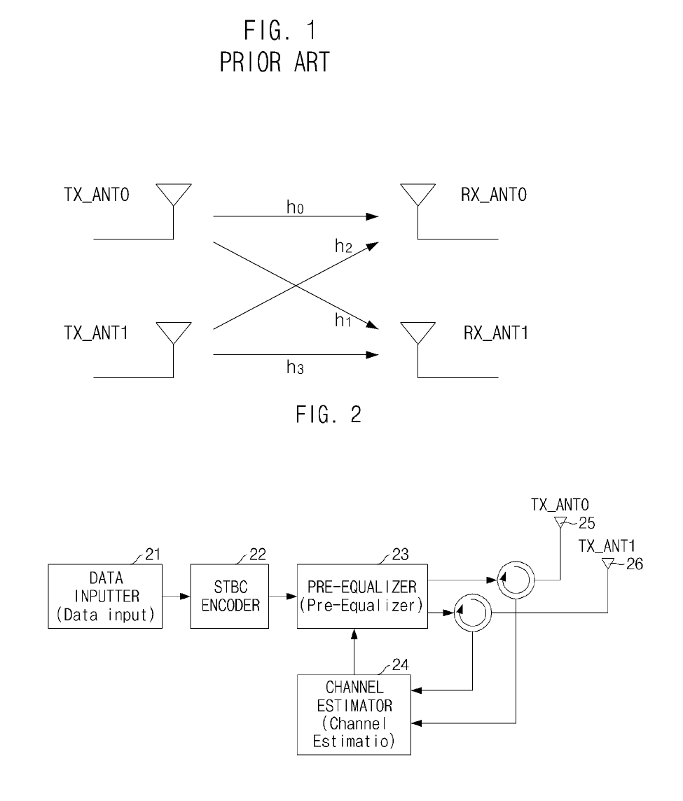

FIG. 2 is a configuration diagram illustrating a transmitter of a MIMO radio communication system using pre-equalization according to an exemplary embodiment.

According to the exemplary embodiment, a structure of a receiver is simplified by the use of pre-equalization, and diversity effect is improved by the use of STBC.

Referring to FIG. 2, the transmitter applied to the MIMO radio communication system using pre-equalization includes a data inputter 21, an STBC encoder 22, a pre-equalizer 23, a channel estimator 24, a first antenna (TX_ANT0) 25, and a second antenna (TX_ANT1) 26.

As shown in Table 1 below, transmit data signals inputted through the data inputter 21 are encoded in space and time domains by the Alamouti STBC encoder 22, and are pre-equalized by the pre-equalizer 23. Then, two pre-equalized data are transmitted through two transmit antennas to a receiver.

TABLE 1

| | ANT0 | ANT1 |
|---|---|---|
| Time t | s₀ | s₁ |
| Time t + T | −s₁* | s₀* |

Meanwhile, information about channel response obtained from receive signals of the antennas upon uplink is used in the pre-equalizer 23 through the channel estimator 24.

The data inputter 21 and the STBC encoder 22 will be referred to an STBC encoding unit. That is, the STBC encoding unit receives the transmit data and performs an STBC encoding to output a plurality of encoded signals. The pre-equalizer 23 and the channel estimator 24 will be referred to as a pre-equalization unit. That is, the pre-equalization unit pre-equalizes the plurality of encoded signals transmitted from the STBC encoding unit by using the channel response, and outputs a plurality of transmit signals.

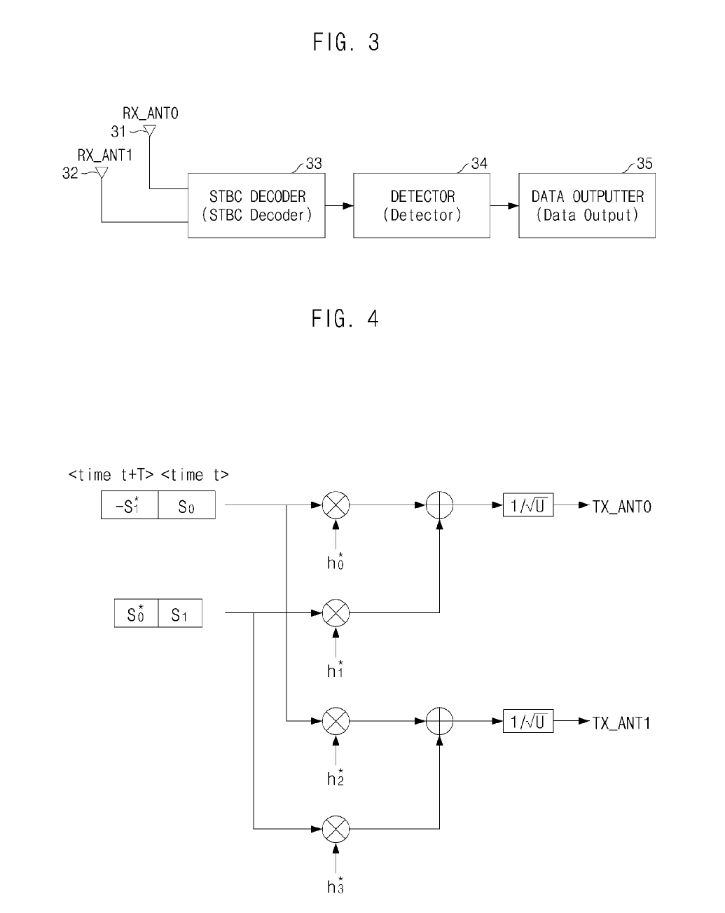

FIG. 3 is a configuration diagram illustrating a receiver of the MIMO radio communication system using pre-equalization according to an exemplary embodiment.

Referring to FIG. 3, the receiver includes a first receive antenna (RX_ANT0) 31, a second receive antenna (RX_ANT1) 32, an STBC decoder 33, a detector 34, and a data outputter 35.

As mentioned above, the exemplary embodiment provides a method for combining signals received at the receive antennas in the STBC decoder. That is, the receiver according to the exemplary embodiment requires no channel estimation. Thus, as illustrated in FIG. 3, the receiver is configured with a simple structure that decodes data signals through an STBC decoding by using only the received signals, without channel estimation. The decoding method will be described below in detail with reference to the accompanying drawings.

The detector 34 and the data outputter 35 output contents of the receive data signals by using the plurality of receive data signals decoded in the STBC decoder 33. The detector 34 and the data outputter 35 will be referred to as a data output unit.

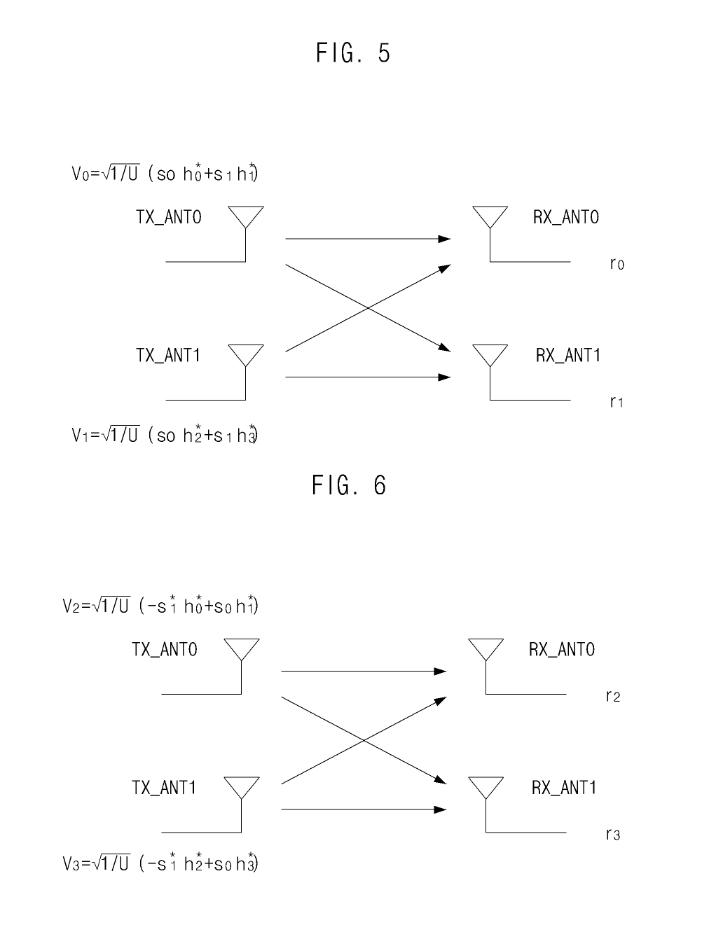

FIG. 4 is a schematic diagram for explaining the function of the transmitter according to the exemplary embodiment. Specifically, FIG. 4 illustrates a method for combining the pre-equalization technique and the STBC encoding in the transmitter. FIGS. 5 and 6 are exemplary diagrams for explaining a MIMO channel environment to which the MIMO radio communication system according to the exemplary embodiment is applied. Specifically, FIG. 5 illustrates a MIMO channel environment at time t, and FIG. 6 illustrates a MIMO channel environment at time t+T.

Regarding a complex channel response, in particular, a 2×2 MIMO channel of FIG. 5, complex channel responses h₀, h₁, h₂ and h₃ may be expressed as Equation (1) below.

h₀=α₀e^{jθ}^{₀}

h₁=α₁e^{jθ}^{₁}

h₂=α₂e^{jθ}^{₂}

h₃=α₃e^{jθ}^{₃} (1)

where αᵢ(i=0,1,2,3) is an amplitude response of the channel, and θᵢ(i=0,1,2,3) is a phase response of the channel.

As mentioned above, the complex channel responses are obtained from the receive signals of the respective antennas upon uplink, inputted through the channel estimator 24 to the pre-equalizer 23, and used in the pre-equalizer 23.

In the transmitter of the base station, two transmit data s₀ and s₁ to be transmitted upon downlink are outputted from the data inputter 21 and inputted to the STBC encoder 22. The two transmit data s₀ and s₁ inputted to the STBC encoder 22 are STBC encoded by the STBC encoder as shown in Table 1. Consequently, two first encoded signals s₀ and s₁ are outputted at time t, and two second encoded signals −s*₁ and s*₀ are outputted at time t+T.

The first encoded signals s₀ and s₁ or the second encoded signals −s*₁ and s*₀ from the STBC encoder 22 are pre-equalized by the pre-equalizer 23 as illustrated in FIG. 4, and then outputted as the transmit signals.

As illustrated in FIG. 5, first transmit signals v₀ and v₁ transmitted through the first transmit antenna TX_ANT0 and the second transmit antenna TX_ANT1 at time t are expressed as Equation (2) below.

$${v}_{0} = \frac{1}{\sqrt{U}} ( {s}_{0} {h}_{0}^{*} + {s}_{1} {h}_{1}^{*} ) \\ {v}_{1} = \frac{1}{\sqrt{U}} ( {s}_{0} {h}_{2}^{*} + {s}_{1} {h}_{3}^{*} ) \qquad ( 2 )$$

In Equation (2), U is a normalizing factor used for making a transmission power constant and is expressed as Equation (3) below.

$$U = {\sum }_{i = 0}^{N - 1} {h}_{i} {h}_{i}^{*} \qquad ( 3 )$$

where N=(number of the transmit antennas)×(number of the receive antennas)

As expressed in Equation (2), the zeroth signal v₀ of the first transmit signals outputted through the first transmit antenna TX_ANT0 at time t is a signal having a value given by multiplying (s₀h*₀+s₁h*₁) by 1/\sqrt{U}, and the first signal v₁ of the first transmit signals outputted through the second transmit antenna TX_ANT1 at time t is a signal having a value given by multiplying (s₀h*₂+s₁h*₃) by 1/\sqrt{U}.

Meanwhile, second transmit signals v₂ and v₃ transmitted through the first transmit antenna TX_ANT0 and the second transmit antenna TX_ANT1 at time t+T are expressed as Equation (4) below and illustrated in FIG. 6.

$$\begin{matrix}{v}_{2} = \frac{1}{\sqrt{U}} ( - {s}_{1}^{*} {h}_{0}^{*} + {s}_{0}^{*} {h}_{1}^{*} ) \\ {v}_{3} = \frac{1}{\sqrt{U}} ( - {s}_{1}^{*} {h}_{2}^{*} + {s}_{0}^{*} {h}_{3}^{*} )\end{matrix} \qquad ( 4 )$$

As expressed in Equation (4), the second signal v₂ of the second transmit signals outputted through the first transmit antenna TX_ANT0 at time t+T is a signal having a value given by multiplying (−s*₁h*₀+s*₀h*₁) by 1/\sqrt{U}, and the third signal v₃ of the second transmit signals outputted through the second transmit antenna TX_ANT1 at time t+T is a signal having a value given by multiplying (−s*₁h*₂+s*₀h*₃) by 1/\sqrt{U}.

That is, as shown in FIG. 4 and expressed in Equations (2) to (4), the transmitter according to the exemplary embodiment multiplies the pre-equalized transmit signals of the respective antennas by 1/\sqrt{U} in the pre-equalizer 23 and then transmits the resulting signals through the transmit antennas.

Meanwhile, the outputs of the pre-equalizer 23 are transmitted through the corresponding transmit antennas, propagated over a 2×2 MIMO channel, and then received by multiple antennas of the receiver of the mobile terminal.

After passing through the channel, first receive signals r₀ and r₁ received by the first receive antenna RX_ANT0 and the second receive antenna RX_ANT1 at time t are expressed as Equations (5) and (6) below.

$$\begin{matrix}\begin{matrix}{r}_{0} = \frac{1}{\sqrt{U}} {v}_{0} {h}_{0} + \frac{1}{\sqrt{U}} {v}_{1} {h}_{2} + {n}_{0} \\ {r}_{1} = \frac{1}{\sqrt{U}} {v}_{0} {h}_{1} + \frac{1}{\sqrt{U}} {v}_{1} {h}_{3} + {n}_{1}\end{matrix} & ( 5 ) \\ \begin{matrix}{r}_{0} = \frac{1}{\sqrt{U}} ( {s}_{0} {h}_{0}^{*} {h}_{0} + {s}_{1} {h}_{1}^{*} {h}_{0} + {s}_{0} {h}_{2}^{*} {h}_{2} + {s}_{1} {h}_{3}^{*} {h}_{2} ) + {n}_{0} \\ {r}_{1} = \frac{1}{\sqrt{U}} ( {s}_{0} {h}_{0}^{*} {h}_{1} + {s}_{1} {h}_{1}^{*} {h}_{1} + {s}_{0} {h}_{2}^{*} {h}_{3} + {s}_{1} {h}_{3}^{*} {h}_{3} ) + {n}_{1}\end{matrix} & ( 6 )\end{matrix}$$

In addition, second receive signals r₂ and r₃ received by the first receive antenna RX_ANT0 and the second receive antenna RX_ANT1 at time t+T are expressed as Equations (7) below.

$$\begin{matrix}{r}_{2} = \frac{1}{\sqrt{U}} ( - {s}_{1}^{*} {h}_{0}^{*} {h}_{0} + {s}_{0}^{*} {h}_{1}^{*} {h}_{0} - {s}_{1}^{*} {h}_{2}^{*} {h}_{2} + {s}_{0}^{*} {h}_{3}^{*} {h}_{2} ) + {n}_{2} \\ {r}_{3} = \frac{1}{\sqrt{U}} ( {s}_{0}^{*} {h}_{1}^{*} {h}_{1} + {s}_{0}^{*} {h}_{3}^{*} {h}_{3} - {s}_{1}^{*} {h}_{0}^{*} {h}_{1} - {s}_{1}^{*} {h}_{2}^{*} {h}_{3} ) + {n}_{3}\end{matrix} \qquad ( 7 )$$

where n₀, n₁, n₂, and n₃ are complex noise components added to the respective receive antennas.

The first receive signals r₀ and r₁ and the second receive signals r₂ and r₃ received from the respective antennas are inputted to the STBC decoder 33 and decoded by using a simple arithmetic operation expressed as Equation (8) below, that is, addition operation.

That is, the outputs of the STBC decoder for the original transmit data signals s₀ and s₁ generated from the data inputter 21 of the transmitter, that is, the receive data signals \tilde{s}₀ and \tilde{s}₁ may be calculated using the decoding method of Equation (8). Equation (9) below is a detailed expression of Equation (8).

$$\begin{matrix}\begin{matrix}{\tilde{s}}_{0} = {r}_{0} + {r}_{3}^{*} \\ {\tilde{s}}_{1} = {r}_{1} - {r}_{2}^{*}\end{matrix} & ( 8 ) \\ \begin{matrix}{\tilde{s}}_{0} = \frac{1}{\sqrt{U}} ( {s}_{0} {h}_{0}^{*} {h}_{0} + {s}_{1} {h}_{1}^{*} {h}_{0} + {s}_{0} {h}_{2}^{*} {h}_{2} + {s}_{1} {h}_{3}^{*} {h}_{2} ) + {n}_{0} + \\ \frac{1}{\sqrt{U}} ( {s}_{0} {h}_{1} {h}_{1}^{*} + {s}_{0} {h}_{3} {h}_{3}^{*} - {s}_{1} {h}_{0} {h}_{1}^{*} - {s}_{1} {h}_{2} {h}_{3}^{*} ) + {n}_{3}^{*} \\ = \frac{1}{\sqrt{U}} {s}_{0} ( {h}_{0}^{*} {h}_{0} + {h}_{1}^{*} {h}_{1} + {h}_{2}^{*} {h}_{2} + {h}_{3}^{*} {h}_{3} ) + {n}_{0} + {n}_{3}^{*}\end{matrix} \\ \begin{matrix}{\tilde{s}}_{1} = \frac{1}{\sqrt{U}} ( {s}_{0} {h}_{0}^{*} {h}_{1} + {s}_{1} {h}_{1}^{*} {h}_{1} + {s}_{0} {h}_{2}^{*} {h}_{3} + {s}_{1} {h}_{3}^{*} {h}_{3} ) + {n}_{1} - \\ \frac{1}{\sqrt{U}} ( - {s}_{1} {h}_{0} {h}_{0}^{*} + {s}_{0} {h}_{1} {h}_{0}^{*} - {s}_{1} {h}_{2} {h}_{2}^{*} + {s}_{0} {h}_{3} {h}_{2}^{*} ) - {n}_{2}^{*} \\ = \frac{1}{\sqrt{U}} {s}_{0} ( {h}_{0}^{*} {h}_{0} + {h}_{1}^{*} {h}_{1} + {h}_{2}^{*} {h}_{2} + {h}_{3}^{*} {h}_{3} ) + {n}_{1} - {n}_{2}^{*}\end{matrix} & ( 9 )\end{matrix}$$

That is, due to the use of Equation (9), the perfect STBC diversity gain can be obtained.

Next, the following description will be made about a MIMO radio communication method using pre-equalization according to an exemplary embodiment, which is executed in the above-mentioned MIMO radio communication system.

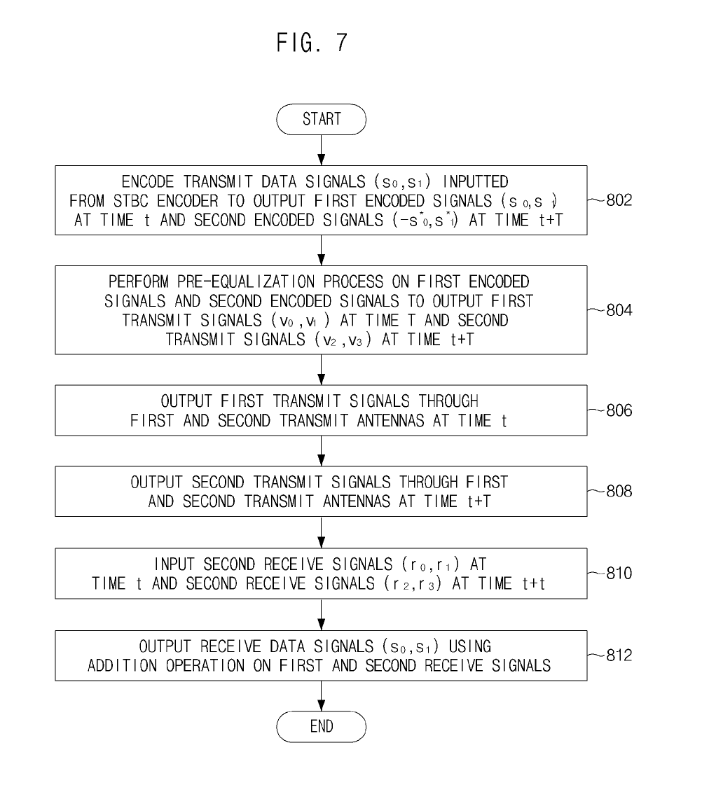

FIG. 7 is a flowchart illustrating a MIMO radio communication method using pre-equalization according to an exemplary embodiment, specifically, a method to be executed in the system described above with reference to FIGS. 2 to 6.

In operation 802, the STBC encoder 22 of the transmitter encodes the transmit data signals s₀ and s₁ received from the data inputter 21 as shown in Table 1, and outputs the first encoded signals s₀ and s₁ at time t and the second encoded signals −s*₁ and s*₀ at time t+T.

In operation 804, the first encoded signals s₀ and s₁ or the second encoded signals −s*₁ and s*₀ from the STBC encoder 22 are inputted to the pre-equalizer 23, and the pre-equalizer 23 performs a pre-equalization process on the first encoded signals s₀ and s₁ and the second encoded signals −s*₁ and s*₀ to output the first transmit signals v₀ and v₁ at time t as expressed in Equation (2) and the second transmit signals v₂ and v₃ at time t+T as expressed in Equation (4). In this case, the pre-equalizer 23 performs the pre-equalization process using the complex channel responses h₀, h₁, h₂ and h₃ transmitted from the channel estimator 24.

In operations 806 and 808, the first transmit signals v₀ and v₁ are outputted at time t through the first transmit antenna TX_ANT0 and the second transmit antenna TX_ANT1, and the second transmit signals v₂ and v₃ are outputted at time t+T through the first transmit antenna TX_ANT0 and the second transmit antenna TX_ANT1.

In operation 810, after passing through the channel, the first receive signals r₀ and r₁ received at time t by the first receive antenna RX_ANT0 and the second receive antenna RX_ANT1, as expressed in Equation (6), and the second receive signals r₂ and r₃ received at time t+T by the first receive antenna RX_ANT0 and the second receive antenna RX_ANT1, as expressed in Equation (7), are inputted to the STBC decoder 33 of the receiver.

In operation 812, the STBC decoder performs an addition operation, like Equations (8) and (9), on the first receive signals r₀ and r₁ and the second receive signals r₂ and r₃, and then outputs the receive data signals \tilde{s}₀ and \tilde{s}₁. The receive data signals \tilde{s}₀ and \tilde{s}₁ are outputted through the detector 34 and the data outputter 35.

As mentioned above, the pre-equalization technique having been implemented only in the MISO channel with a single receive antenna is implemented in the MIMO channel with multiple (2×2) receive antenna.

That is, the related art MIMO antenna transmission technique using STBC requires channel estimation for all paths arriving at multiple receive antennas from multiple transmit antennas, and performs an STBC decoding using the obtained channel estimation values. Thus, the structure of the receiver is complicated. However, according to the exemplary embodiments, since the pre-equalizer is also used in the MIMO channel environment, the receiver requires no channel estimation and thus the structure of the receiver is simplified. Moreover, the use of the STBC is also possible. Although the above description has been made based on the 2×2 MIMO channel environment, the present invention is not limited thereto. For example, the present invention can also be applied to MIMO channel environments using multiple transmit antennas and multiple receive antennas, in addition to the 2×2 MIMO channel environment.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A transmitter of a Multiple Input Multiple Output (MIMO) radio communication system, the transmitter comprising:
a Space Time Block Coding (STBC) encoding unit receiving a transmit data and performing an STBC encoding to output a plurality of encoded signals;
a pre-equalization unit performing a pre-equalization process on the plurality of encoded signals, which are transmitted from the STBC encoding unit, to output a plurality of transmit signals; and
a transmit antenna unit transmitting the plurality of transmit signals at different time.

2. The transmitter of claim 1, wherein the pre-equalization unit performs the pre-equalization process using a channel response received and obtained upon uplink.

3. The transmitter of claim 1, wherein the pre-equalization unit generates the plurality of transmit signals using a normalizing factor for making a transmission power constant.

4. The transmitter of claim 1, wherein the transmit antenna unit comprises two or more transmit antennas and transmits the plurality of transmit signals through the different transmit antennas at the different time.

5. The transmitter of claim 1, wherein the pre-equalization unit comprises:
a pre-equalizer performing the pre-equalization process on the plurality of encoded signals; and
a channel estimator transmitting a channel response, which is generated using information received upon uplink, to the pre-equalizer in order to enable the channel response to be used in the pre-equalization.

6. The transmitter of claim 1, wherein the pre-equalization unit generates the plurality of transmit signals using a normalizing factor for making a transmission power constant.

7. A receiver of a Multiple Input Multiple Output (MIMO) radio communication system, the receiver comprising:
a receive antenna unit comprising two or more antennas and receiving a plurality of signals through the two or more antennas at different time;
a Space Time Block Coding (STBC) decoding unit performing an STBC decoding on the plurality of received signals to output a plurality of receive data signals; and
a data output unit outputting contents of the receive data signals.

8. The receiver of claim 7, wherein the STBC decoding unit outputs the receive data signals by performing the STBC decoding on the plurality of received signals by using an arithmetic operation without channel estimation.

9. A transmitting method of a Multiple Input Multiple Output (MIMO) radio communication system, the transmitting method comprising:
generating a plurality of encoded signals with respect to a transmit data;
performing a pre-equalization process on the plurality of encoded signals to output a plurality of transmit signals; and
transmitting the plurality of transmit signals at different time.

10. The transmitting method of claim 9, wherein the generating of the plurality of transmit signals comprises:
confirming a channel response obtained upon uplink; and
performing the pre-equalization process using the channel response.

11. The transmitting method of claim 9, wherein the plurality of transmit signals are generated using a normalizing factor for making a transmission power constant.

12. The transmitting method of claim 9, wherein the transmitting of the plurality of transmit signals comprises:
allocating a plurality of transmit antennas to the plurality of transmit signals, respectively; and
transmitting the plurality of transmit signals through the plurality of transmit antennas at different time.

13. A receiving method of a Multiple Input Multiple Output (MIMO) radio communication system, the receiving method comprising:
receiving a plurality of receive signals through a plurality of antennas at different time;
generating a receive data signal by performing a Space Time Block Coding (STBC) decoding on the plurality of received signals by using an arithmetic operation; and
outputting the receive data.

14. The receiving method of claim 13, wherein the receive data signal is generated using an arithmetic operation on the plurality of receive signals without channel estimation.
